(19) United States
(12) Patent Application Publication
(10) Pub. No.: US 2009/0051678 A1
(43) Pub. Date: Feb. 26, 2009

(54) Active Matrix Display Apparatus

(76) Inventors: Masakazu Satoh, Nara (JP); Tomoyuki Nagai, Mie (JP); Kazuhiro Maeda, Kyoto (JP); Tamotsu Sakai, Nara (JP); Shuji Nishi, Nara (JP)

Correspondence Address: HARNESS, DICKEY & PIERCE, P.L.C., P.O. BOX 8910, RESTON, VA, 20195, US

(21) Appl. No.: 11/887,783

(22) PCT Filed: Apr. 3, 2006
(86) PCT No.: PCT/JP2006/307066

§ 371 Date: Oct. 3, 2007

(30) Foreign Application Priority Data
Jun. 15, 2005 (JP) 2005-175041

(51) Int. Cl. G06F 3/038

(52) U.S. Cl. 345/213

(57) ABSTRACT

A readily-mountable low-cost active matrix display apparatus with a setup function is provided. A serial interface circuit 20 and setup circuits 16 are each formed of TFT elements on a liquid crystal panel 11. The serial interface circuit 20 performs serial-parallel conversion on a setup control signal 17 serially inputted via setup terminals 15. The setup circuits 16 change the states of signals flowing in the liquid crystal panel 11 in accordance with signals outputted in parallel from the serial interface circuit 20. Thus, it is possible to change the potential, timing, etc., of signals inputted to or outputted from any peripheral circuits formed on the liquid crystal panel 11 or any peripheral circuits included in a semiconductor chip mounted on the surface of the liquid crystal panel 11.

### TECHNICAL FIELD

The present invention relates to display apparatuses, and particularly to active matrix display apparatuses such as liquid crystal display apparatuses and electroluminescence display apparatuses.

### BACKGROUND ART

The active matrix display apparatuses are known as display apparatuses having display elements arranged two-dimensionally. The active matrix display apparatuses have a display panel, which is configured such that scanning signal lines and data signal lines are provided in lattice form on a transparent insulating substrate, a switching element is provided in the vicinity of each intersection between the two types of signal lines, and a pixel electrode is provided in each grid of the lattice. For example, a TFT (Thin Film Transistor) element, an MIM (Metal-Insulator-Metal) element, or the like, is used as the switching element. The pixel electrode and the switching element are connected in one-to-one correspondence, both of which are associated with a single display element.

In general, to display a screen on the display panel, a display element drive circuit, a timing signal generation circuit, a potential generation circuit, etc., are required as peripheral circuits for the display panel. Display apparatuses included in large-sized electronic equipment (e.g., large-screen televisions) have their peripheral circuits mainly provided on a printed circuit board different from the display panel. On the other hand, some display apparatuses included in medium- or small-sized electronic equipment (e.g., cell phones) employ, for example, the COG (Chip On Glass) scheme to mount a semiconductor chip, which includes peripheral circuits, on the surface of the display panel, thereby reducing equipment size.

Also, some display apparatuses are provided with a function for setting operating conditions of the display panel (hereinafter, referred to as a “panel setup function”). For example, the display apparatuses are provided with a function for adjusting the potential that is to be applied to the display elements. By using such a display apparatus with the panel setup function, it becomes possible to suitably control display image quality, display apparatus power consumption, and so on.

The display panel of the active matrix display apparatus is fabricated using process technology capable of forming display elements including a switching element. Accordingly, when fabricating the display panel, circuits that support the panel setup function (hereinafter, referred to as “setup circuits”) can be formed on the display panel along with the display elements. For example, in the case of forming the display elements using TFT elements, the setup circuits can also be formed on the display panel using TFT elements.

FIG. 7 is a block diagram illustrating the configuration of a conventional liquid crystal display apparatus with the setup function. The liquid crystal display apparatus 90 shown in FIG. 7 includes b setup circuits 96. The setup circuits 96, along with display elements in a pixel array 12, are each formed of TFT elements on a liquid crystal panel 91. From outside the liquid crystal display apparatus 90, display data signals, etc., are supplied to a scanning signal line drive circuit 13 and a data signal line drive circuit 14. In addition, m setup control signals 97 are supplied to the setup circuits 96 via setup terminals 95.

Note that inventions relevant to the present invention are disclosed in the following documents. Patent Document 1 discloses that thin film transistors are used to form first level conversion means, serial-parallel conversion means, and second level conversion means on an insulating substrate, the first level conversion means boosting serially-inputted low-voltage display data signals, the second level conversion means attenuating parallel data signals. Patent Document 2 discloses that thin film transistors are used to form pixels on an insulating substrate, and a frame memory is integrally formed on the substrate. Patent Document 3 discloses a drive device for a liquid crystal display apparatus, in which information representing designated on/off timing is held, and switching elements are turned on/off in accordance with the information being held. Patent Document 4 discloses that the waveform of a drive signal to be applied to a liquid crystal panel is set or changed in accordance with a waveform information signal, which is transferred in serialized state.

[Patent Document 1] Japanese Laid-Open Patent Publication No. 2004-4242

[Patent Document 2] Japanese Laid-Open Patent Publication No. 2004-138918

[Patent Document 3] Japanese Laid-Open Patent Publication No. 8-95000

[Patent Document 4] Japanese Laid-Open Patent Publication No. 2000-28998

### DISCLOSURE OF THE INVENTION

### Problems to be Solved by the Invention

Conventional display apparatuses have a problem in that they become difficult to mount when a number of setup circuits are formed on the display panel, leading to an increase in cost. For example, the liquid crystal display apparatus 90 shown in FIG. 7 requires a specialized semiconductor chip to be provided outside the apparatus in order to supply the setup control signals 97 to the setup circuits 96. Accordingly, the need arises to add a chip mounting step to the process for fabricating the liquid crystal display apparatus 90, increasing the cost of fabricating the liquid crystal display apparatus 90 by the cost of the semiconductor chip itself and the cost of the chip mounting step. In addition, the liquid crystal panel 91 is limited in terms of the space available for arranging terminals. Thus, if the number of terminals is increased, it becomes necessary to narrow the intervals between the terminals, which makes it difficult to carry out the mounting.

Therefore, the present invention aims to provide a readily-mountable low-cost active matrix display apparatus with the panel setup function.

### Solution to the Problems

A first aspect of the present invention is directed to an active matrix display apparatus with a setup function, comprising:

a display panel on which a plurality of display elements are formed, each display element having an individual switching element;

a serial-to-parallel conversion circuit for performing serial-to-parallel conversion on a first control signal inputted in a serial format from outside the apparatus, and outputting a second control signal, the serial-to-parallel conversion circuit being formed on the display panel along with the display elements; and

a setup circuit for changing a state of a signal flowing in the display panel in accordance with the second control signal, the setup circuit being formed on the display panel along with the display elements.

In a second aspect of the invention, based on the first aspect of the invention, further comprised is a peripheral circuit formed on the display panel along with the display elements, and the setup circuit changes a state of a signal inputted to or outputted from the peripheral circuit in accordance with the second control signal.

In a third aspect of the invention, based on the first aspect of the invention, further comprised is a peripheral circuit included in a semiconductor chip mounted on a surface of the display panel, and the setup circuit changes a state of a signal inputted to or outputted from the peripheral circuit in accordance with the second control signal.

In a fourth aspect of the invention, based on the first aspect of the invention, further comprised are a timing signal generation circuit for generating a predetermined timing signal, and a drive circuit for driving the display elements in accordance with the timing signal, and the setup circuit changes output timing of the timing signal in accordance with the second control signal.

In a fifth aspect of the invention, based on the first aspect of the invention, further comprised is a drive circuit for driving the display elements in accordance with a provided offset operation potential, and the setup circuit changes the offset operation potential in accordance with the second control signal.

In a sixth aspect of the invention, based on the first aspect of the invention, further comprised are a gradation potential generation circuit for generating a gradation potential in accordance with a provided reference potential, and a drive circuit for driving the display elements in accordance with the gradation potential, and the setup circuit changes the reference potential in accordance with the second control signal.

In a seventh aspect of the invention, based on the first aspect of the invention, further comprised are a reference potential generation circuit for generating a predetermined reference potential, and a level shifter for converting a potential of a signal inputted from outside the apparatus in accordance with the reference potential, and the setup circuit changes the reference potential in accordance with the second control signal.

In an eighth aspect of the invention, based on the first aspect of the invention, further comprised is a sensor unit for measuring a predetermined physical quantity, and the setup circuit changes an operating condition of the sensor unit in accordance with the second control signal.

In a ninth aspect of the invention, based on the first aspect of the invention, the first control signal is inputted from outside the apparatus by means of a clock signal line, a data signal line, and an enable signal line.

In a tenth aspect of the invention, based on the first aspect of the invention, the switching element is formed of a thin film transistor.

### EFFECT OF THE INVENTION

According to the first aspect of the invention, the serial-to-parallel conversion circuit and the setup circuit are provided on the panel, and therefore there is no need to provide a specialized semiconductor chip outside the panel in order to supply a setup control signal. Thus, it is possible to eliminate the need to add a chip mounting step to the fabrication process of the display apparatus, thereby keeping down the fabrication cost of the display apparatus. In addition, the first control signal can be inputted using only a small number of terminals, and therefore it is possible to eliminate the need to narrow the intervals between the terminals in order to input the first control signal, making it easy to carry out the mounting.

According to the second aspect of the invention, it is possible to change the state of a signal inputted to or outputted from the peripheral circuit formed on the display panel along with the display elements.

According to the third aspect of the invention, it is possible to change the state of a signal inputted to or outputted from the peripheral circuit included in the semiconductor chip mounted on the surface of the display panel.

According to the fourth aspect of the invention, it is possible to drive the display elements at a suitable time.

According to the fifth or sixth aspect of the invention, it is possible to suitably control display image quality.

According to the seventh aspect of the invention, it is possible to suitably control the level of a signal outputted from the level shifter.

According to the eighth aspect of the invention, it is possible to suitably control the sensing function of the sensor unit.

According to the ninth aspect of the invention, it is possible to input the first control signal using only a small number of signal lines.

According to the tenth aspect of the invention, it is possible to achieve a readily-mountable low cost liquid crystal display apparatus.

### BRIEF DESCRIPTION OF THE DRAWINGS

FIG. 1 is a block diagram illustrating the configuration of a liquid crystal display apparatus according to an embodiment of the present invention.

FIG. 2 is a block diagram illustrating a detailed configuration of a serial interface circuit in the liquid crystal display apparatus shown in FIG. 1.

FIG. 3 is a timing chart for the serial interface circuit in the liquid crystal display apparatus shown in FIG. 1.

FIG. 4 is a block diagram illustrating a detailed configuration of the liquid crystal display apparatus shown in FIG. 1.

FIG. 5 is a block diagram illustrating a detailed configuration of a setup circuit provided in a gradation potential generation circuit in the liquid crystal display apparatus shown in FIG. 1.

FIG. 6 is a circuit diagram of a high-side reference potential adjustment circuit in the liquid crystal display apparatus shown in FIG. 1.

FIG. 7 is a block diagram illustrating the configuration of a conventional liquid crystal display apparatus.

### DESCRIPTION OF THE REFERENCE CHARACTERS

10 liquid crystal display apparatus
11 liquid crystal panel
12 pixel array
13 scanning signal line drive circuit
14 data signal line drive circuit
15 setup terminal
16,40 setup circuit
17 setup control signal
20 serial interface circuit
21 input buffer
22 flip-flop
23 level shifter
24 latch
25 output buffer
30 RAM
31 reference potential generation circuit
32 timing signal generation circuit
33 level shifter
34 common electrode drive circuit
35 DC/DC conversion circuit
36 optical sensor unit
37 gradation potential generation circuit

### BEST MODE FOR CARRYING OUT THE INVENTION

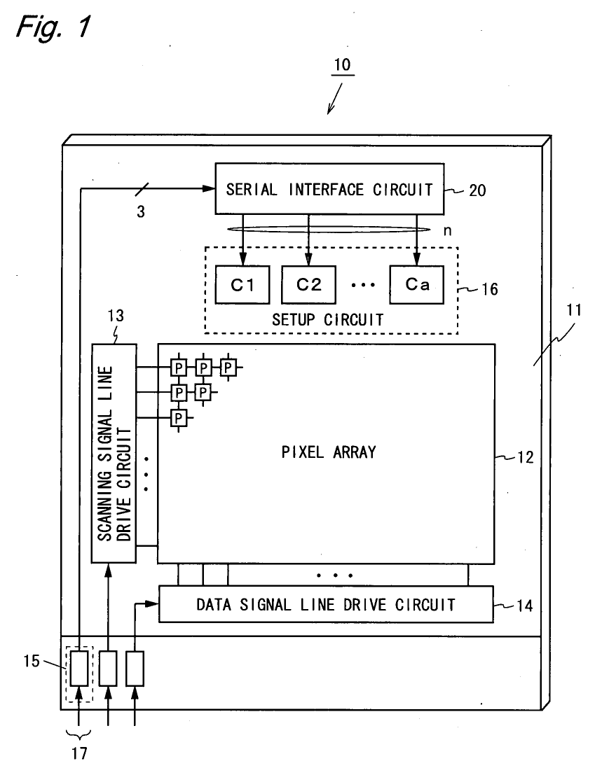

FIG. 1 is a block diagram illustrating the configuration of a liquid crystal display apparatus according to an embodiment of the present invention. The liquid crystal display apparatus 10 shown in FIG. 1 is an active matrix display apparatus in which an active matrix liquid crystal panel and its drive circuits are integrally formed. The liquid crystal display apparatus 10 includes a liquid crystal panel 11, a pixel array 12, a scanning signal line drive circuit 13, a data signal line drive circuit 14, setup terminals 15, setup circuits 16, and a serial interface circuit 20.

The liquid crystal panel 11 has a plurality of display elements (represented by rectangles assigned with character P) formed in matrix form. The display elements each include a switching element formed of a TFT element, and as a whole constitute the pixel array 12. The scanning signal line drive circuit 13 selects a row of display elements from the pixel array 12. The data signal line drive circuit 14 writes data to the row of display elements selected by the scanning signal line drive circuit 13. The scanning signal line drive circuit 13 and the data signal line drive circuit 14 are provided in a semiconductor chip, which is mounted on the surface of the liquid crystal panel 11, by the COG scheme. Alternatively, the scanning signal line drive circuit 13 and the data signal line drive circuit 14 may be entirely or partly formed on the liquid crystal panel 11 using TFT elements.

The liquid crystal display apparatus 10 includes a setup circuits 16. The setup circuits 16, along with the display elements in the pixel array 12, are each formed of a TFT element on the liquid crystal panel 11. The setup circuits 16 set operating conditions of the liquid crystal panel 11 in accordance with provided control signals. Specifically, the setup circuits 16 change the states (potential, timing, etc.) of signals flowing in the liquid crystal panel 11 in accordance with the provided control signals. In the liquid crystal display apparatus 10, n control signals are provided for the a setup circuits 16.

Three terminals (a clock signal terminal, a data signal terminal, and an enable signal terminal) are provided as the setup terminals 15. From outside the liquid crystal display apparatus 10, a clock signal CLK, a data signal DATA, and an enable signal ENB are inputted via the clock signal terminal, the data signal terminal, and the enable signal terminal, respectively.

The serial interface circuit 20 is provided between the setup terminals 15 and the setup circuits 16. The serial interface circuit 20 performs serial-parallel conversion (serial-to-parallel conversion) on a setup control signal 17 inputted in a serial format from outside the liquid crystal display apparatus 10, and outputs resultant n signals in parallel to the setup circuits 16. The setup circuits 16 change the states of signals flowing in the liquid crystal panel 11 in accordance with the setup control signals outputted in parallel from the serial interface circuit 20.

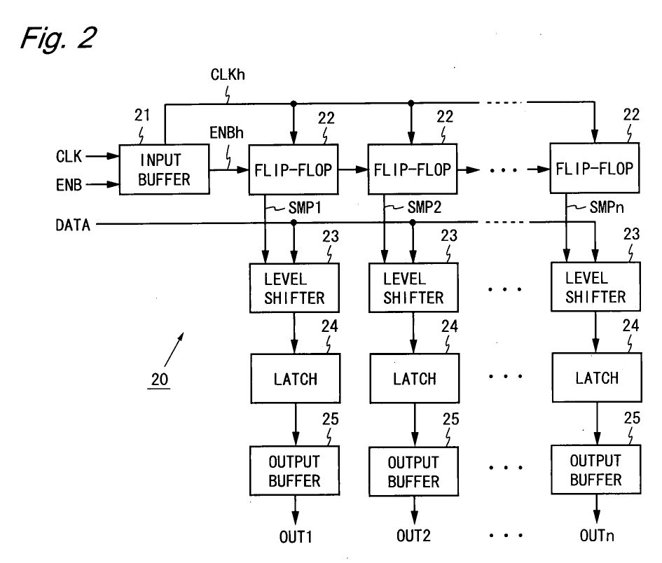

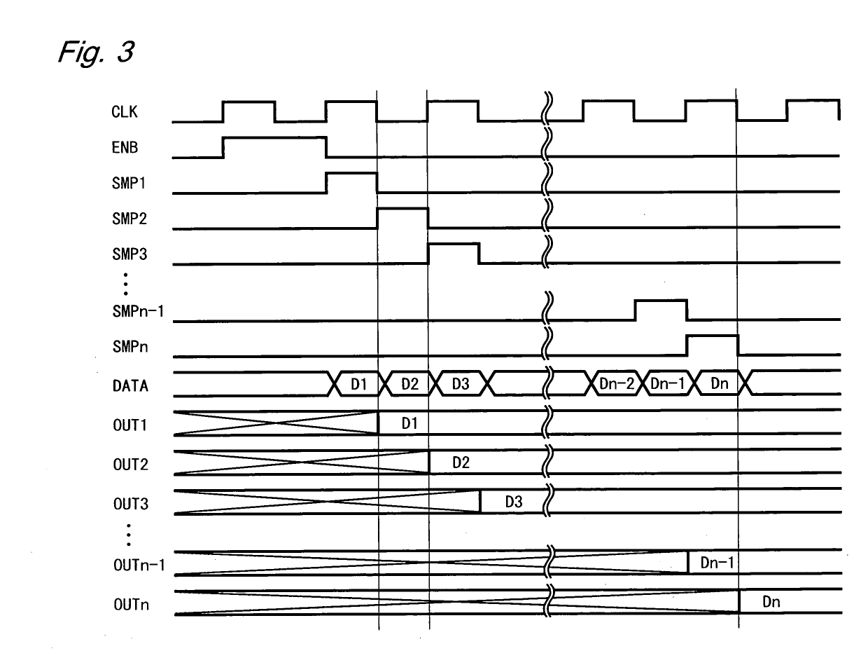

FIG. 2 is a block diagram illustrating a detailed configuration of the serial interface circuit 20. FIG. 3 is a timing chart for the serial interface circuit 20. Referring to FIGS. 2 and 3, the serial interface circuit 20 will be described in detail.

As shown in FIG. 2, the serial interface circuit 20 includes an input buffer 21, n flip-flops 22, n level shifters 23, n latches 24, and n output buffers 25. The n flip-flops 22 are cascaded to constitute an n-stage shift register. The level shifters 23, the latches 24, and the output buffers 25 are provided in association with their corresponding stages in the shift register.

The serial interface circuit 20 receives three signals (the clock signal CLK, the data signal DATA, and the enable signal ENB) via the setup terminals 15. Of these three signals, the data signal DATA is the setup control signal that is to be supplied to the setup circuits 16. The clock signal CLK is a signal that designates the time at which to change the data signal DATA, and the enable signal ENB is a signal that designates the time at which to start inputting the data signal DATA. These three signals change at a first voltage amplitude (a low voltage amplitude; e.g., an amplitude of 3V).

The input buffer 21 level-shifts the clock signal CLK and the enable signal ENB to signals (hereinafter, referred to as a “clock signal CLKh” and an “enable signal ENBh”, respectively) that change at a second voltage amplitude (a high-voltage amplitude; e.g., an amplitude of 8V).

The data input terminal of the flip-flop 22 at the first stage receives the enable signal ENBh, while the data input terminals of the flip-flops 22 at the second and subsequent stages receive an output signal from the flip-flop 22 at the previous stage. In addition, all clock terminals of the flip-flops 22 at the first to n'th stages receive the clock signal CLKh. When the clock signal CLKh changes, the flip-flops 22 at the first to n'th stages memorize therein the output signal from the flip-flop 22 at the previous stage (or the enable signal ENBh).

The output signals from the flip-flops 22 are referred to as “sampling signals SMP1 to SMPn”. As a whole, the n flip-flops 22 shift the sampling signals SMP1 to SMPn by one bit as the clock signal CLK changes. Accordingly, as shown in FIG. 3, the sampling signals SMP1 to SMPn are activated (in FIG. 3, high level) in the order: SMP1, SMP2, . . . , SMPn, as the clock signal changes.

The level shifter 23 corresponding to the flip-flop 22 at the i'th stage (where i is an integer from 1 to n, inclusively) receives the data signal DATA that changes at the first voltage amplitude and the sampling signal SMPi that changes at the second voltage amplitude. During the active state of the sampling signal SMPi, the level shifter 23 level-shifts the data signal DATA that changes at the first voltage amplitude to the signal that changes at the second voltage amplitude.

Provided at the stage following the level shifter 23 is the latch 24, and provided at the stage following the latch 24 is the output buffer 25. The latch 24 holds the signal level-shifted by the level shifter 23. The output buffer 25 outputs the signal held in the latch 24 to the setup circuit 16.

The data signal DATA takes value D1 when the sampling signal SMP1 is active, and subsequently takes values D2, D3, . . . , Dn as the clock signal CLK changes. In addition, the latch 24 corresponding to the flip-flop 22 at the i'th stage holds the data signal DATA having been level-shifted during the active state of the sampling signal SMPi. Accordingly, after the sampling signal SMPi changes from active to inactive, the output buffer 25 corresponding to the flip-flop 22 at the i'th stage outputs value Di (see FIG. 3).

As such, the serial interface circuit 20 performs serial-parallel conversion on the setup control signal 17 inputted in a serial format from outside the liquid crystal display apparatus 10, and outputs the resultant n signals in parallel to the setup circuits 16.

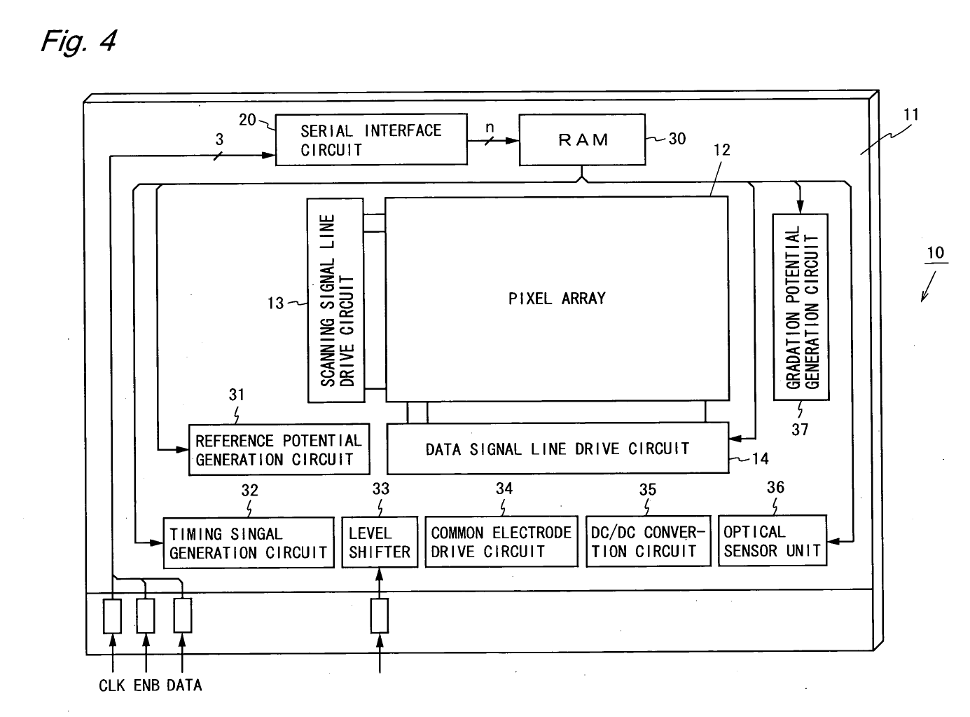

FIG. 4 is a block diagram illustrating a detailed configuration of the liquid crystal display apparatus 10. As shown in FIG. 4, an n-bit RAM 30 is provided at the stage following the serial interface circuit 20. The RAM 30 is formed of TFT elements on the liquid crystal panel 11 along with the display elements in the pixel array 12. The RAM 30 memorizes n signals, which are outputted in parallel from the serial interface circuit 20, at a predetermined time (e.g., when all the n signals are prepared).

As shown in FIG. 4, the liquid crystal panel 11 is also provided with peripheral circuits other than the scanning signal line drive circuit 13 and the data signal line drive circuit 14, such as a reference potential generation circuit 31, a timing signal generation circuit 32, a level shifter 33, a common electrode drive circuit 34, a DC/DC conversion circuit 35, an optical sensor unit 36, and a gradation potential generation circuit 37. These peripheral circuits are each formed of TFT elements on the liquid crystal panel 11. Alternatively, all or part of these peripheral circuits may be provided in a semiconductor chip mounted on the surface of the liquid crystal panel 11.

Of the peripheral circuits shown in FIG. 4, the data signal line drive circuit 14, the reference potential generation circuit 31, the timing signal generation circuit 32, the optical sensor unit 36, and the gradation potential generation circuit 37 are provided with a setup circuit 16 as shown in FIG. 1 (omitted in FIG. 4). The peripheral circuits with the setup circuit 16 receive output signals from the RAM 30 to the degree required.

The reference potential generation circuit 31 generates a reference potential Vbias to be referenced by the level shifter 33. In accordance with the reference potential Vbias generated by the reference potential generation circuit 31, the level shifter 33 level-shifts the potential of a signal (such as a display data signal) inputted from outside the liquid crystal display apparatus 10 to a potential to be used on the liquid crystal panel 11. More specifically, the level shifter 33 outputs a signal at high level (e.g., 8V) when the potential of the inputted signal is equal to or more than the reference potential Vbias, and a signal at low level (e.g., 0V) in other cases.

The setup circuit provided in the reference potential generation circuit 31 changes the reference potential Vbias in accordance with output signals from the RAM 30 (i.e., in accordance with the setup control signals outputted in parallel from the serial interface circuit 20). Thus, the output signal of the level shifter 33 can be suitably controlled in terms of its level.

The timing signal generation circuit 32 generates timing signals (a start pulse, a clock signal, etc.) to be supplied to the scanning signal line drive circuit 13 and the data signal line drive circuit 14. The scanning signal line drive circuit 13 and the data signal line drive circuit 14 drive the display elements in the pixel array 12 in accordance with the timing signals generated by the timing signal generation circuit 32.

The setup circuit provided in the timing signal generation circuit 32 changes the output timing of the timing signals in accordance with output signals from the RAM 30. For example, the setup circuit shifts the output timing of the timing signals several clock cycles before or after the standard timing in units of a ¼ clock cycle in accordance with the output signals from the RAM 30. Thus, the display elements in the pixel array 12 can be driven at a suitable time.

In the pixel array 12, a common electrode is provided so as to face pixel electrodes included in the display elements. The common electrode drive circuit 34 applies a predetermined potential to the common electrode. The DC/DC conversion circuit 35 converts a potential supplied from outside the liquid crystal display apparatus 10 into a potential required in the liquid crystal display apparatus 10. Note that in the liquid crystal display apparatus 10 shown in FIG. 4, the common electrode drive circuit 34 and the DC/DC conversion circuit 35 are not provided with any setup circuit, but these two peripheral circuits may be provided with a setup circuit.

The optical sensor unit 36 outputs a signal that changes stepwise in accordance with the illuminance of incident light. The setup circuit provided in the optical sensor unit 36 changes operating conditions of the optical sensor unit 36 in accordance with output signals from the RAM 30. For example, in accordance with the output signals from the RAM 30, the setup circuit may select one bias potential from among a plurality of bias potentials supplied from outside, or it may change the threshold for an inverter provided at the output stage of a comparator or the range of illuminance to be determined. Thus, the sensing function of the optical sensor unit 36 can be suitably controlled.

The gradation potential generation circuit 37 generates gradation potentials to be supplied to the data signal line drive circuit 14 in accordance with a provided reference potential. The data signal line drive circuit 14 drives the display elements in the pixel array 12 in accordance with the gradation potentials generated by the gradation potential generation circuit 37.

The setup circuit provided in the gradation potential generation circuit 37 changes the reference potential in accordance with output signals from the RAM 30. Thus, the gradation potentials can be suitably controlled, and the display image quality can be suitably controlled.

The setup circuit provided in the data signal line drive circuit 14 changes an offset potential for a video buffer in accordance with output signals from the RAM 30. Thus, the display image quality can be suitably controlled.

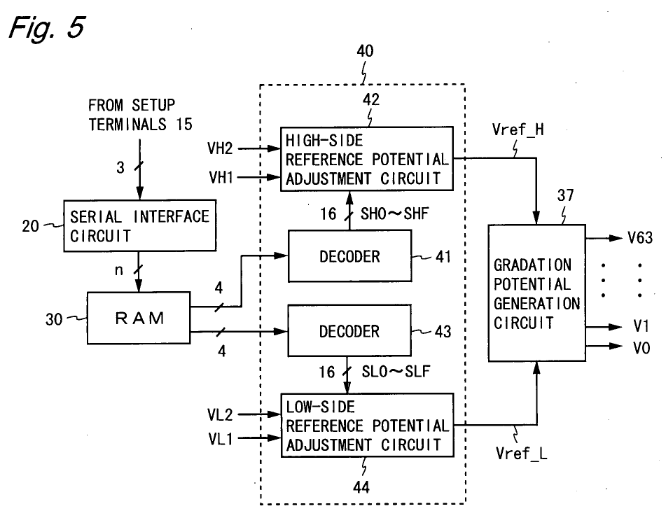

FIG. 5 is a block diagram illustrating a detailed configuration of the setup circuit provided in the gradation potential generation circuit 37. The setup circuit 40 shown in FIG. 5 includes decoders 41 and 43, a high-side reference potential adjustment circuit 42, and a low-side reference potential adjustment circuit 44. The setup circuit 40 changes a high-side reference potential Vref_H and a low-side reference potential Vref_L, which are supplied to the gradation potential generation circuit 37, each in sixteen ways.

The decoder 41 decodes four signals outputted from the RAM 30, and outputs sixteen decoded signals SH0 to SHF. Any one of the decoded signals SH0 to SHF is active (here, low level) while the others are inactive (here, high level).

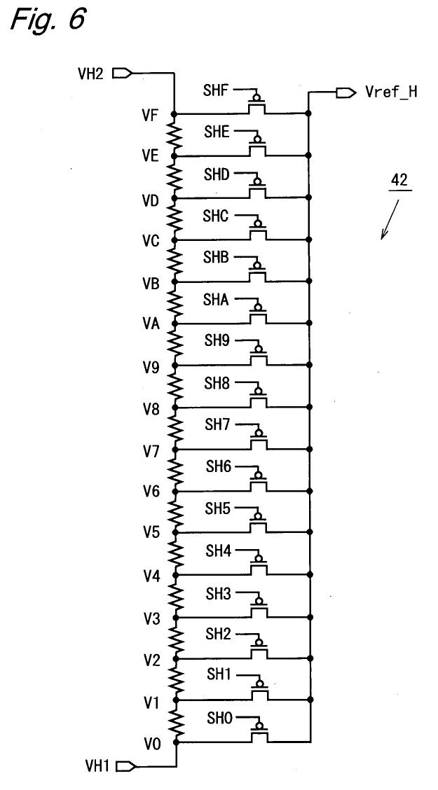

FIG. 6 is a circuit diagram of the high-side reference potential adjustment circuit 42. Inputted to the high-side reference potential adjustment circuit 42 area first potential VH1, a second potential VH2 higher than that, and the decoded signals SH0 to SHF outputted from the decoder 41. The high-side reference potential adjustment circuit 42 includes fifteen resistors serially connected between the first potential VH1 and the second potential VH2. These resistors form a resistive divider circuit. The resistive divider circuit generates sixteen potentials V0 to VF in the range from the first potential VH1 to the second potential VH2, inclusively.

The high-side reference potential adjustment circuit 42 includes sixteen switches, which are turned on/off under control of the decoded signals SH0 to SHF. The switches are connected at one end to their respective contact points in the potential range from V0 to VF, and at the other end to a common output terminal. As described above, one of the decoded signals SH0 to SHF is active, and therefore the potential Vref_H at the output terminal of the high-side reference potential adjustment circuit 42 is in the potential range from V0 to VF. The potential Vref_H generated by the high-side reference potential adjustment circuit 42 is used as a high-side reference potential in the gradation potential generation circuit 37.

The decoder 43 and the low-side reference potential adjustment circuit 44 are configured in the same manner as the decoder 41 and the high-side reference potential adjustment circuit 42, respectively. However, the low-side reference potential adjustment circuit 44 receives first and second potentials VL1 and VL2 different from those for the high-side reference potential adjustment circuit 42. The potential Vref_L generated by the low-side reference potential adjustment circuit 44 is used as a low-side reference potential in the gradation potential generation circuit 37.

As such, the decoder 41 and the high-side reference potential adjustment circuit 42 change the high-side reference potential Vref_H of the gradation potential generation circuit 37 in sixteen ways in accordance with output signals from the RAM 30, while the decoder 43 and the low-side reference potential adjustment circuit 44 change the low-side reference potential Vref_L of the gradation potential generation circuit 37 in sixteen ways in accordance with output signals from the RAM 30.

While the setup circuit provided in the gradation potential generation circuit 37 has been described herein as an example of the setup circuits, the other setup circuits can be configured similarly. In addition, the liquid crystal panel 11 is provided with the RAM 30, but in place of this, a circuit for holding output signals may be added to the serial interface circuit 20.

The liquid crystal display apparatus 10 may also include sensor units (e.g., a touch panel, a fingerprint sensor, and a temperature sensor) in addition to the optical sensor unit 36, and the setup circuits 16 may change operating conditions of the sensor units in accordance with output signals from the RAM 30. In addition, the setup circuits 16 may change the states of signals inputted to or outputted from any peripheral circuits formed on the liquid crystal panel 11 along with the display elements in the pixel array 12, or the states of signals inputted to or outputted from any peripheral circuits included in the semiconductor chip mounted on the surface of the liquid crystal panel 11.

As indicated above, the liquid crystal display apparatus 10 according to the present embodiment includes the serial interface circuit 20 and the setup circuits 16, both of which are each formed of TFT elements on the liquid crystal panel 11. The serial interface circuit 20 performs serial-parallel conversion on the setup control signal 17 inputted in a serial format via the setup terminals 15. The setup circuits 16 change the states of signals flowing in the liquid crystal panel 11 in accordance with signals outputted in parallel from the serial interface circuit 20. Thus, the states of signals inputted to or outputted from the peripheral circuits formed on the liquid crystal panel 11 or the peripheral circuits included in the semiconductor chip mounted on the surface of the liquid crystal panel 11 are changed in terms of potential and timing.

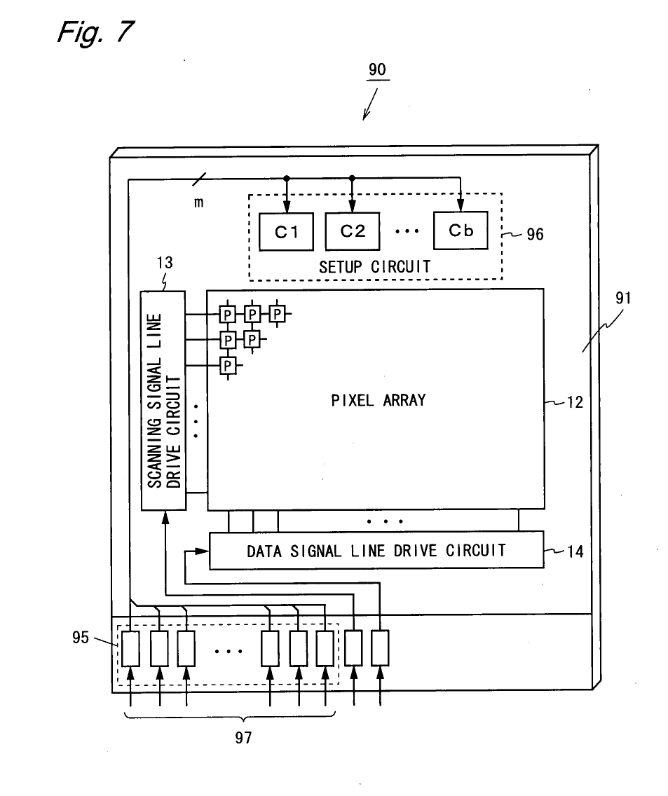

Accordingly, unlike the conventional liquid crystal display apparatus 90 (FIG. 7), the liquid crystal display apparatus 10 includes the serial interface circuit 20 and the setup circuits 16 on the liquid crystal panel 11, and therefore does not require a specialized semiconductor chip to be provided outside the apparatus in order to supply the setup control signal. Thus, it is possible to eliminate the need to add the chip mounting step to the fabrication process of the liquid crystal display apparatus 10, thereby keeping down the fabrication cost of the liquid crystal display apparatus 10. In addition, the liquid crystal display apparatus 10 uses only three setup terminals 15 to input the setup control signal 17, and therefore eliminates the need to narrow the intervals between the terminals in order to input the setup control signal, making it easy to carry out the mounting. Thus, it is possible to achieve a readily-mountable low-cost active matrix display apparatus with the panel setup function.

While the liquid crystal display apparatus has been described as an example of the active matrix display apparatuses, an electroluminescence display apparatus with the panel setup function can be configured in the same fashion.

### INDUSTRIAL APPLICABILITY

The active matrix display apparatus of the present invention has a serial-to-parallel conversion circuit and setup circuits formed on the display panel, and therefore has such characteristics as being readily-mountable and low-cost while having the setup function. Thus, it can be used as a liquid crystal display apparatus, an electroluminescence display apparatus, etc.

1. An active matrix display apparatus with a setup function, comprising:
a display panel on which a plurality of display elements are formed, each display element having an individual switching element;
a serial-to-parallel conversion circuit for performing serial-to-parallel conversion on a first control signal inputted in a serial format from outside the apparatus, and outputting a second control signal, the serial-to-parallel conversion circuit being formed on the display panel along with the display elements; and
a setup circuit for changing a state of a signal flowing in the display panel in accordance with the second control signal, the setup circuit being formed on the display panel along with the display elements.

2. The display apparatus according to claim 1, further comprising a peripheral circuit formed on the display panel along with the display elements,
wherein the setup circuit changes a state of a signal inputted to or outputted from the peripheral circuit in accordance with the second control signal.

3. The display apparatus according to claim 1, further comprising a peripheral circuit included in a semiconductor chip mounted on a surface of the display panel,
wherein the setup circuit changes a state of a signal inputted to or outputted from the peripheral circuit in accordance with the second control signal.

4. The display apparatus according to claim 1, further comprising:
a timing signal generation circuit for generating a predetermined timing signal; and
a drive circuit for driving the display elements in accordance with the timing signal,
wherein the setup circuit changes output timing of the timing signal in accordance with the second control signal.

5. The display apparatus according to claim 1, further comprising a drive circuit for driving the display elements in accordance with a provided offset operation potential,
wherein the setup circuit changes the offset operation potential in accordance with the second control signal.

6. The display apparatus according to claim 1, further comprising:
a gradation potential generation circuit for generating a gradation potential in accordance with a provided reference potential; and
a drive circuit for driving the display elements in accordance with the gradation potential,
wherein the setup circuit changes the reference potential in accordance with the second control signal.

7. The display apparatus according to claim 1, further comprising:
a reference potential generation circuit for generating a predetermined reference potential; and
a level shifter for converting a potential of a signal inputted from outside the apparatus in accordance with the reference potential,
wherein the setup circuit changes the reference potential in accordance with the second control signal.

8. The display apparatus according to claim 1, further comprising a sensor unit for measuring a predetermined physical quantity,
wherein the setup circuit changes an operating condition of the sensor unit in accordance with the second control signal.

9. The display apparatus according to claim 1, wherein the first control signal is inputted from outside the apparatus by means of a clock signal line, a data signal line, and an enable signal line.

10. The display apparatus according to claim 1, wherein the switching element is formed of a thin film transistor.
